(19) United States
(12) Patent Application Publication
(10) Pub. No.: US 2025/0389598 A1
(43) Pub. Date: Dec. 25, 2025

(54) FLUIDIC TACTILE SENSOR

(71) Applicant: Sanctuary Cognitive Systems (USA) Corporation, Wilmington, DE (US)

(72) Inventors: Jeremy A. Fishel, Chico, CA (US); William Cortez, Chico, CA (US); Jason L. Vasquez, Chico, CA (US)

(21) Appl. No.: 19/234,591

(22) Filed: Jun. 11, 2025

Related U.S. Application Data
(60) Provisional application No. 63/663,096, filed on Jun. 22, 2024.
(60) Provisional application No. 63/755,592, filed on Feb. 7, 2025.

(51) Int. Cl. G01L 5/00; B25J 13/08; G01L 9/04

(52) U.S. Cl. CPC G01L 5/0061; B25J 13/084; G01L 9/045

(57) ABSTRACT

A fluidic tactile sensor includes a core and an elastic skin mechanically coupled to the core. A cell containing a fluid medium is formed in a space defined between opposing surfaces of the core and the elastic skin. A fluid leakage passage is formed in the core and is in fluid communication with the cell. An orifice member is fixed within the fluid leakage passage. The orifice member includes an orifice that is tuned to restrict fluid flow through the fluid leakage passage and limit a fluid leakage rate of the cell.

### CROSS-REFERENCE TO RELATED APPLICATIONS

This application claims the benefit of U.S. Provisional Application No. 63/663,096, filed Jun. 22, 2024, and U.S. Provisional Application No. 63/755,592, filed Feb. 7, 2025, the contents of which are incorporated herein by reference.

### FIELD

The field generally relates to robotics and particularly to tactile sensing in robotics.

### BACKGROUND

Robots are machines that can sense their environments and perform tasks autonomously or semi-autonomously or via teleoperation. A humanoid robot is a robot or machine having an appearance and/or character resembling that of a human. Humanoid robots can be designed to function as team members with humans in diverse applications, such as construction, manufacturing, monitoring, exploration, learning, and entertainment. Humanoid robots can be particularly advantageous in substituting for humans in environments that may be dangerous to humans or uninhabitable by humans.

### SUMMARY

Disclosed herein is a tactile sensor that can be attached to a surface of an object to provide the object with tactile sensing at the surface. The tactile sensor is a fluid-based sensor that measures the response of pressure in a fluid cell to contact forces.

In a representative example, a fluidic tactile sensor includes a core having a ventral surface and a dorsal surface and an elastic skin mechanically coupled to the core. The elastic skin has an inner surface and an outer surface. The inner surface is in opposing relation to the ventral surface of the core. The fluidic tactile sensor includes a cell formed in a space defined between the ventral surface of the core and the inner surface of the elastic skin. The cell contains a fluid medium. A fluid leakage passage is formed in the core and is in fluid communication with the cell. An orifice member is fixed within the fluid leakage passage. The orifice member includes an orifice that is tuned to restrict fluid flow through the fluid leakage passage and limit a fluid leakage rate of the cell.

### BRIEF DESCRIPTION OF THE DRAWINGS

FIG. 1 is a perspective view of a fluidic tactile sensor according to one example.

FIG. 2A is a cross-sectional view of the fluidic tactile sensor shown in FIG. 1 and illustrates an elastic skin having an inner surface including a raised surface texture.

FIG. 2B is a cross-sectional view of the fluidic tactile sensor taken along line 2B-2B as depicted in FIG. 2A.

FIG. 3 is a cross-sectional view of the fluidic tactile sensor shown in FIG. 1 and illustrates an elastic skin having an inner surface including a raised surface texture that is different from the one shown in FIG. 2A.

FIG. 4 illustrates the raised surface texture shown in FIG. 2A engaging a ventral surface of a core of the fluidic tactile sensor in an engaged position.

FIG. 5 is a cross-sectional view of the fluidic tactile sensor shown in FIG. 1 with an inflation port and a valve arranged in a core of the fluidic tactile sensor.

FIG. 6 is a perspective view of the fluidic tactile sensor of FIG. 1 attached to a distal phalanx of a robotic digit.

FIG. 7A is a perspective view of a fluidic tactile sensor according to another example.

FIG. 7B is a cross-sectional view of the fluidic tactile sensor shown in FIG. 7A.

FIG. 7C is a a cross-sectional view of the fluidic tactile sensor shown in FIG. 7A according to another example.

FIG. 8A is a top view of an orifice device in the fluidic tactile sensor shown in FIG. 7B.

FIG. 8B is a top view of the orifice device shown in FIG. 7B with an added porous filter.

FIG. 9 is a graph of pressure profiles in a sensor with an orifice device.

### DETAILED DESCRIPTION

### General Considerations

For the purpose of this description, certain specific details are set forth herein in order to provide a thorough understanding of disclosed technology. In some cases, as will be recognized by one skilled in the art, the disclosed technology may be practiced without one or more of these specific details, or may be practiced with other methods, structures, and materials not specifically disclosed herein. In some instances, well-known structures and/or processes associated with robots have been omitted to avoid obscuring novel and non-obvious aspects of the disclosed technology.

All the examples of the disclosed technology described herein and shown in the drawings may be combined without any restrictions to form any number of combinations, unless the context clearly dictates otherwise, such as if the proposed combination involves elements that are incompatible or mutually exclusive. The sequential order of the acts in any process described herein may be rearranged, unless the context clearly dictates otherwise, such as if one act or operation requests the result of another act or operation as input.

In the interest of conciseness, and for the sake of continuity in the description, same or similar reference characters may be used for same or similar elements in different figures, and description of an element in one figure will be deemed to carry over when the element appears in other figures with the same or similar reference character, unless stated otherwise. In some cases, the term “corresponding to” may be used to describe correspondence between elements of different figures. In an example usage, when an element in a first figure is described as corresponding to another element in a second figure, the element in the first figure is deemed to have the characteristics of the other element in the second figure, and vice versa, unless stated otherwise.

The word “comprise” and derivatives thereof, such as “comprises” and “comprising”, are to be construed in an open, inclusive sense, that is, as “including, but not limited to”. The singular forms “a”, “an”, “at least one”, and “the” include plural referents, unless the context dictates otherwise. The term “and/or”, when used between the last two elements of a list of elements, means any one or more of the listed elements. The term “or” is generally employed in its broadest sense, that is, as meaning “and/or”, unless the context clearly dictates otherwise. When used to describe a range of dimensions, the phrase “between X and Y” represents a range that includes X and Y. As used herein, an “apparatus” may refer to any individual device, collection of devices, part of a device, or collections of parts of devices.

The term “coupled” without a qualifier generally means physically coupled or lined and does not exclude the presence of intermediate elements between the coupled elements absent specific contrary language. The term “plurality” or “plural” when used together with an element means two or more of the element. Directions and other relative references (e.g., inner and outer, upper and lower, above and below, and left and right) may be used to facilitate discussion of the drawings and principles but are not intended to be limiting.

The headings and Abstract are provided for convenience only and are not intended, and should not be construed, to interpret the scope or meaning of the disclosed technology.

### Example I—Overview

Described herein is a tactile sensor that can be attached to a surface of an object to provide the object with tactile sensing at the surface. The tactile sensor can be adapted for attachment to any portion of an external surface of the robot, providing the robot with the ability to be sensitive to contacts and collisions. The tactile sensor is a fluid-based sensor that measures the response of pressure in a fluid cell to contact forces. The tactile sensor uses a raised surface texture of an elastic structure to widen the dynamic force range of the tactile sensor.

### Example II—Fluidic Tactile Sensor

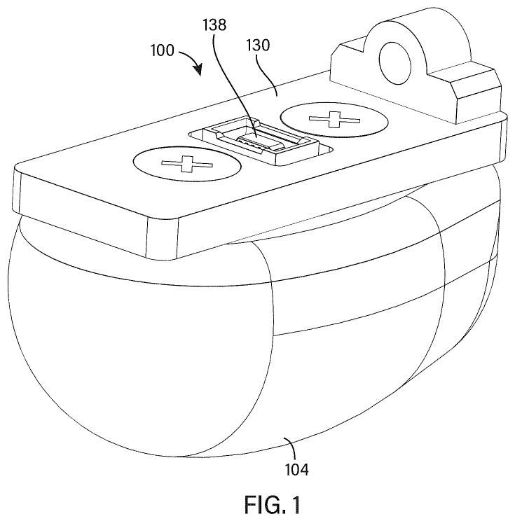

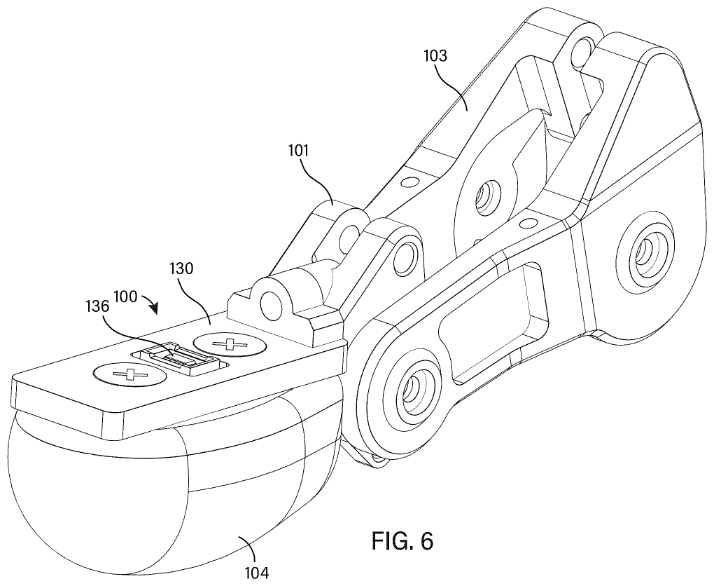

FIGS. 1-5 illustrate an exemplary fluidic tactile sensor 100 that can be attached to a surface of interest to enable tactile sensing at the surface. In some examples, the surface of interest can be any external surface of a robot where tactile sensing is desired (e.g., any external surface of a robotic hand or end effector). In the illustrated examples, the fluidic tactile sensor 100 is shaped like a fingertip and can be attached to a distal phalanx of a robotic finger (as shown, for example, in FIG. 6). In other examples, the fluidic tactile sensor 100 could have a different shape than shown in FIGS. 1-5 for attachment to other parts of a robot.

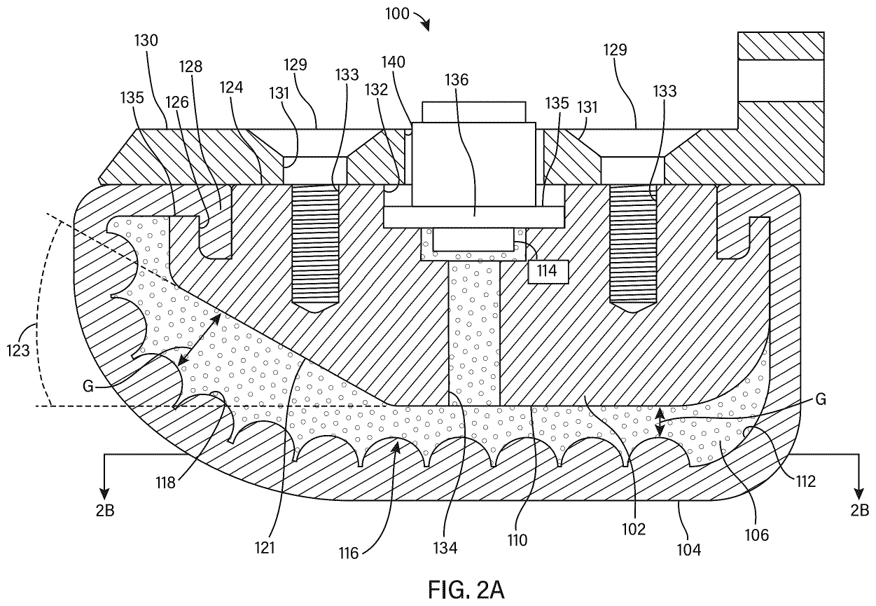

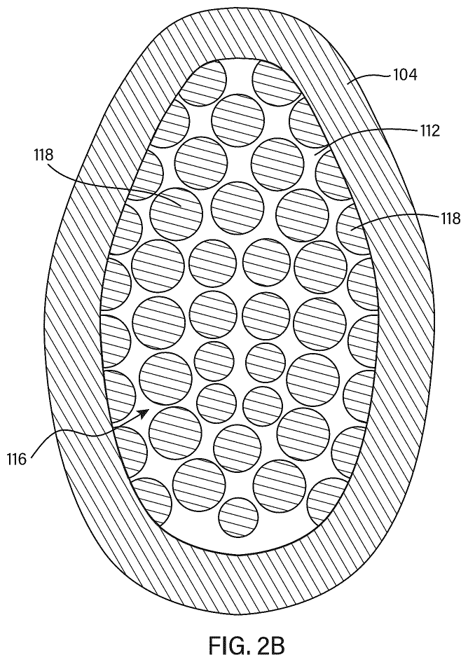

As shown more clearly in FIG. 2A, the fluidic tactile sensor 100 includes a core 102, an elastic skin 104 coupled to the core 102, and a cell 106 occupying a space between the core 102 and the elastic skin 104. The cell 106 is bounded by a ventral surface 110 of the core 102 and an inner surface 112 of the elastic skin 104 that is in opposing relation to the ventral surface 110 of the core 102. The cell 106 contains a compressible fluid (e.g., a gaseous medium). In some examples, the cell 106 contains air, e.g., ambient air or compressed air.

When a contact force is applied to the elastic skin 104 (e.g., by touching or colliding with the elastic skin from the exterior of the tactile sensor), the elastic skin 104 deforms, causing a change in the volume of the cell 106, which can result in a measurable change in the fluid pressure inside the cell 106. The fluidic tactile sensor 100 includes a pressure transducer 114 arranged to sense fluid pressure changes inside the cell 106. The pressure measurements can be mapped to tactile sensing data (e.g., the amount of contact force being applied to the elastic skin).

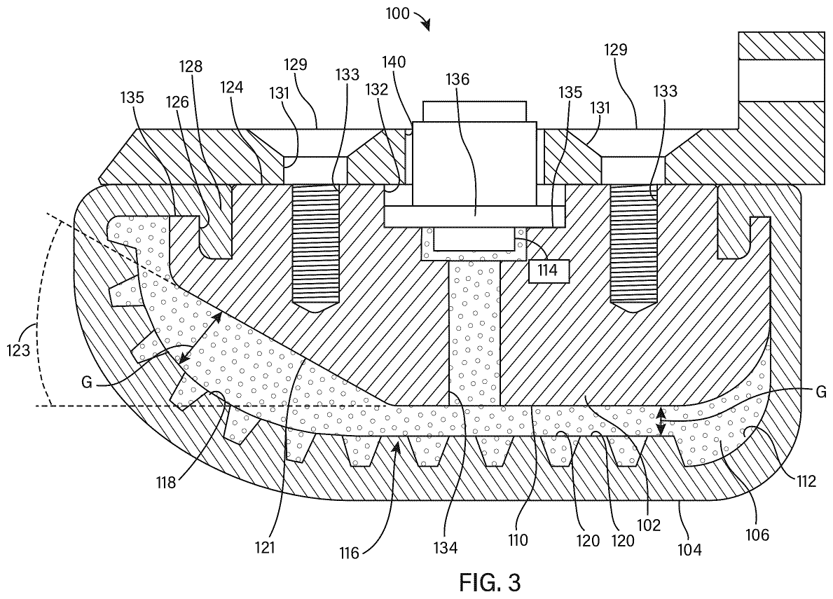

In the illustrated examples, the inner surface 112 of the elastic skin 104 includes a raised surface texture 116 that protrudes into the cell 106. In one example, the raised surface texture 116 includes discrete 3D (three-dimensional) structures arrayed across the inner surface 112 of the elastic skin 104. The discrete 3D structures can be arranged in any suitable array pattern (e.g., triangular pattern, square pattern, hexagonal pattern, or irregular pattern) and have any suitable profile (e.g., spherical profile, cylindrical profile, or frustoconical profile). FIGS. 2A and 2B show an example where the raised surface texture 116 includes discrete 3D structures 118 with a spherical profile. In another example, the raised surface texture 116 can include intersecting 3D structures extending across the inner surface of the elastic skin 104. The intersecting 3D structures can form any suitable grid pattern and have any suitable cross-sectional shape (e.g., square cross-section or tapered cross-section). The intersecting 3D structures may be linear 3D structures or nonlinear 3D structures. FIG. 3 shows an example where the raised surface texture 116 includes linear 3D structures 120 intersecting to form a grid (e.g., a waffle structure).

The raised surface texture 116 has a free position in which the 3D structures in the raised surface texture 116 are separated from the ventral surface 110 of the core 102 by a tuning gap G (see FIGS. 2A and 3). A portion of the raised surface texture 116 may also be described as being in a free position if the portion is separated from the ventral surface 110 of the core 102 by the tuning gap G. The tuning gap G may be uniform across the cell 106 or may be nonuniform across the cell 106. The tuning gap G represents a distance through which a corresponding 3D structure of the raised surface texture 116 may travel before engaging the ventral surface 110 of the core 102. The raised surface texture 116 is in an engaged position when any portion of the raised surface texture 116 is engaged with (e.g., contacts) the ventral surface 110 of the core 102. A portion of the raised surface texture 116 that is engaged with the ventral surface 110 of the core 102 may also be described as being in an engaged position.

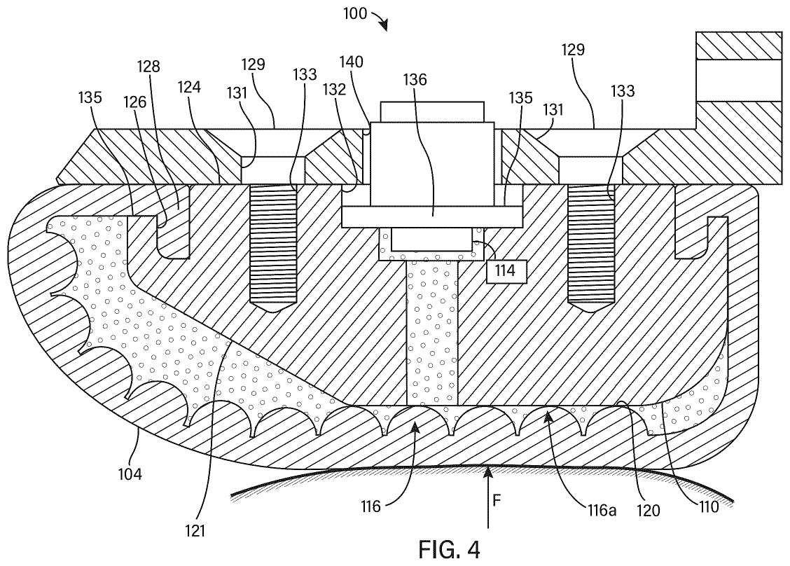

When any portion of the raised surface texture 116 engages the ventral surface 110 of the core 102 in response to applying a contact force to the elastic skin 104, the portion of the raised surface texture 116 engaging the ventral surface 110 of the core 102 forms a compression spring that resists the contact force applied to the elastic skin 104. FIG. 4 shows an example of applying a contact force F to the elastic skin 104 that results in a portion 116a of the raised surface texture 116 engaging the ventral surface 110 of the core 102. As the contact force F is increased, the compression spring formed by the portion 116a deforms. The maximum deflection of the compression spring (or maximum spring compression) corresponds to the largest force to which the fluidic tactile sensor 100 can be sensitive. Thus, the raised surface texture 116 has the effect of widening the dynamic range of the tactile sensor 100 (i.e., widening beyond the range that is available with just the fluid in the cell 106). When the contact force is released from the elastic skin 104, the stored energy in the compression spring releases the portion 116a of the raised surface texture 116 from the ventral surface 110 of the core 102, which can act to return the elastic skin 104 to a neutral position away from the core 102 (e.g., as shown in FIG. 2).

The dynamic range of the fluidic tactile sensor 100 is characterized by two different stiffness ranges, a low-stiffness range that is impacted by the height of the tuning gap G and a high-stiffness range that is impacted by the height of the raised surface texture 116. In a given portion of the fluidic tactile sensor where the tuning gap G is non-zero (e.g., the 3D structures in the given portion do not engage the ventral surface 110 of the core 102, or the given portion is in a free position), the fluidic tactile sensor is in the low-stiffness range where the stiffness of the fluidic tactile sensor responds to the height of the tuning gap in the given portion (e.g., becomes stiffer as the height of the tuning gap decreases and the fluid in the tuning gap is compressed). In a given portion of the fluidic tactile sensor where the tuning gap is zero (e.g., the 3D structures in the given portion engage the ventral surface 110 of the core 102, or the given portion is in an engaged position), the fluidic tactile sensor is in the high-stiffness range where the stiffness of the fluidic tactile sensor responds to the height of the 3D structures in the given portion (e.g., becomes stiffer as the height of the 3D structures decreases, or the 3D structures are compressed).

Returning to FIGS. 2A and 3, the elastic skin 104, including the raised surface texture 116, can be formed from an elastomer (e.g., silicone) or other suitable resilient material. In some examples, the material of the elastic skin 104 is substantially impermeable to the fluid contained in the cell 106 (or the elastic skin 104 can be coated with a material that is substantially impermeable to the fluid contained in the cell 106). In some examples, the elastic skin 104 with the raised surface texture 116 on its inner surface can be formed by molding.

The core 102 can be a relatively rigid core (e.g., more rigid compared to the elastic skin 104). For example, the core 102 can be formed from hard plastic or metal. In the illustrated example, the core 102 is nonplanar and has a shape of a tip of a distal phalanx (or fingertip shape). In other examples, the core 102 may have a different nonplanar shape or may have a planar shape. In the illustrated example, the ventral surface 110 of the core 102 is a curved surface. The ventral surface 110 includes an inclined flattened region 121 corresponding to an apical tuft of a distal phalanx. The angle 123 of the inclined flat region 121 relative to a plane parallel to a dorsal surface 124 of the core 102 may be in a range from 30 to 45 degrees. In some examples, the size of the tuning gap G that separates the raised surface texture 116 from the ventral 110 may be a different size (e.g., a larger size) in the inclined flattened region 121 compared to other regions of the ventral surface 110.

The dorsal surface 124 of the core 102 can include an annular groove 126 that receives a peripheral portion 128 of the elastic skin 104. The annular groove 126 may have an undercut to assist in locking the peripheral portion to the core 102. In some examples, the tactile sensor 100 can include a dorsal plate 130 that can be mounted on the dorsal surface 124 of the core 102. The dorsal plate 130 can extend over the peripheral portion 128 of the elastic skin 104 such that when the dorsal plate 130 is clamped to the core 102, the dorsal plate 130 can apply a force to the peripheral portion 128 that enables the peripheral portion 128 to function as a gasket sealing the cell 106 at the perimeter of the core 102. The dorsal plate 130 may be clamped to the core 102, for example, by inserting threaded fasteners 129 into aligned holes 131 in the dorsal plate 130 and threaded holes 133 in the core 102 and making up the threads between the threaded fasteners 129 and the threaded holes 133. Other methods of sealing the elastic skin 104 to the core 102 at perimeter of the core 102 may be used (e.g., sealing with O-rings or diaphragms).

The core 102 can include a chamber 132 having an outer opening at the dorsal surface 124. The core 102 can include a channel 134 extending from an inner opening of the chamber 132 to the ventral surface 110 and thereby fluidly connecting the chamber 132 to the cell 106. The pressure transducer 114 is mounted on a seat 135 formed in the chamber 132 and extends over the opening of the channel 134. The cell 106 is sealed at the perimeter of the chamber 132 (e.g., by disposing epoxy at the interface between the pressure transducer 114 and the seat 135 or by forming an annular groove in the chamber that surrounds a perimeter of the portion of the pressure transducer 114 mounted on the seat 135 and providing a sealing ring or gasket in the annular groove that seals between the inner perimeter of the chamber 132 and the outer perimeter of the pressure transducer 114). The dorsal plate 130 can include an opening 140 providing access to the pressure transducer 114.

The pressure transducer 114 is exposed to the fluid pressure in the cell 106 via the channel 134. The pressure transducer 114 includes a pressure-sensitive element that can measure fluid pressure and convert the measurements into an electric output signal. The pressure transducer 114 can be, for example, a strain gauge pressure transducer. In some cases, the pressure transducer 114 may further include a temperature sensor. Temperature measurements from the temperature sensor can be used in interpreting the pressure measurements. A circuit board 136 can be coupled to the side of the pressure transducer 114 that is not exposed to the channel 134. The circuit board 136 may extend through the opening 140 in the dorsal plate 130 and may be communicatively coupled to other systems of the robot. The circuit board 136 contains electrical circuity that can communicate with the pressure transducer 114 (e.g., receive electrical output signals from the pressure transducer 114 and provide electrical power to the pressure transducer 114).

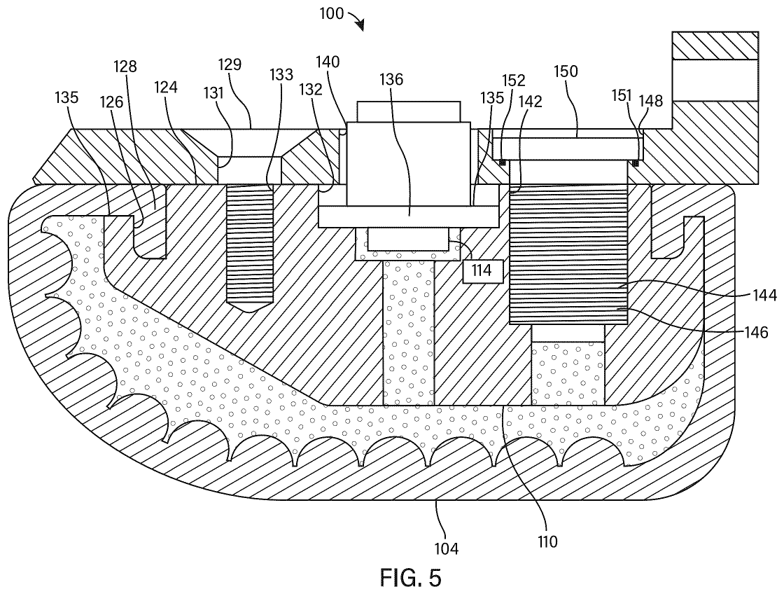

In some examples, as illustrated in FIG. 5, the core 102 can include an inflation port 142 that extends from the dorsal surface 124 of the core 102 to the ventral surface 110 of the core 102. In some examples, a removable plug may be mounted in the inflation port 142 that allows filling of the cell 106 after assembling the tactile sensor. In other examples, a valve 144 may be installed in the inflation port 142 and used to inflate or reinflate the cell 106 with fluid as needed. The fluid may be pressurized fluid or ambient fluid (e.g., air). In some examples, the valve 144 may work passively to inflate the cell 106 when the pressure of the fluid in the cell is below ambient pressure. In some examples, the valve 144 may be a miniaturized one-way valve.

The valve 144 may be installed in the inflation port 142 using any suitable method. In some examples, the valve 144 may have a threaded body 146 that threadedly engages the inflation port 142. A threaded sealant may be applied to the threaded connection to seal the cell 106 at the perimeter of the inflation port 142. In some examples, the dorsal plate 130 may have a hole 148 that is aligned with the inflation port 142 so that the inflation port 142 and valve 144 are accessible after the tactile sensor is assembled. The valve 144 may have a cap 150 that engages a seat 151 in the hole 148. A sealant (e.g., epoxy may be provided between the cap 150 and seat 151 or between the perimeter of the cap 150 and wall of the hole 148) to further seal the cell 106 at the perimeter of the hole 148. A sealing ring 152 may be provided between the shoulder 151 and cap 150 to form a seal at the perimeter of the hole 148. In general, any suitable method of installing the valve 144 in the inflation port 142 and sealing the cell 106 at the inflation port 142 may be used.

### Example III—Robotic Finger with Fluidic Tactile Sensor

FIG. 6 shows the fluidic tactile sensor 100 coupled to a distal phalanx 101 of a robotic finger. The distal phalanx 101 is shown coupled to a proximal phalanx 103, which can be coupled to other parts of the robotic finger not shown (e.g., metacarpal).

### Example IV—Fluidic Tactile Sensor with Orifice Device

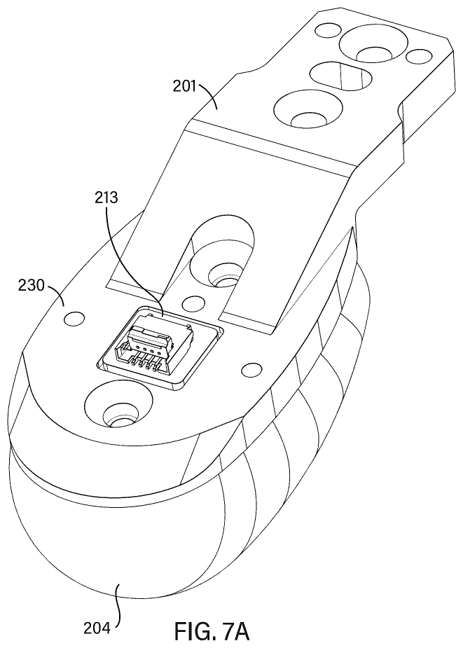

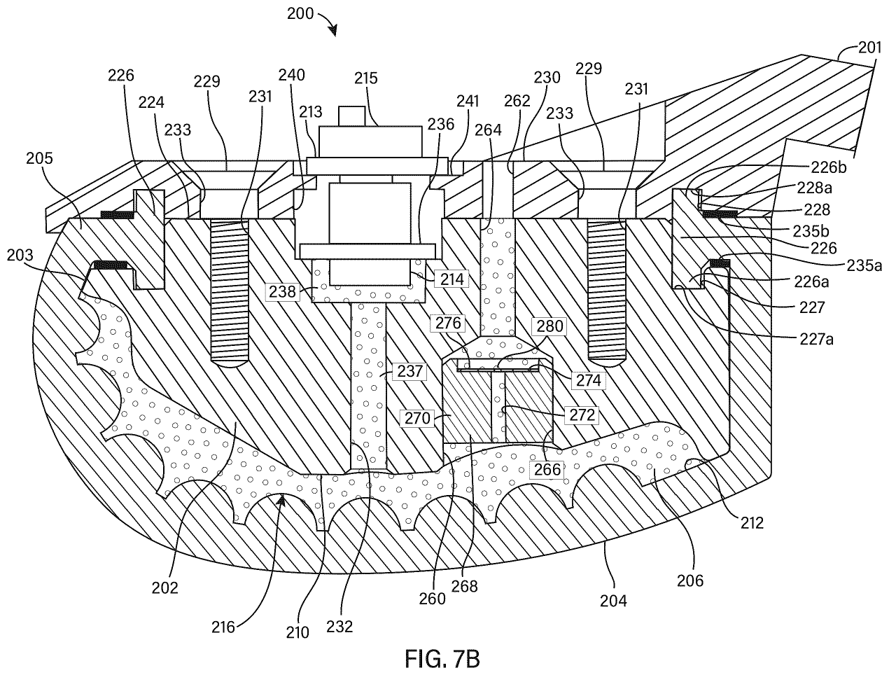

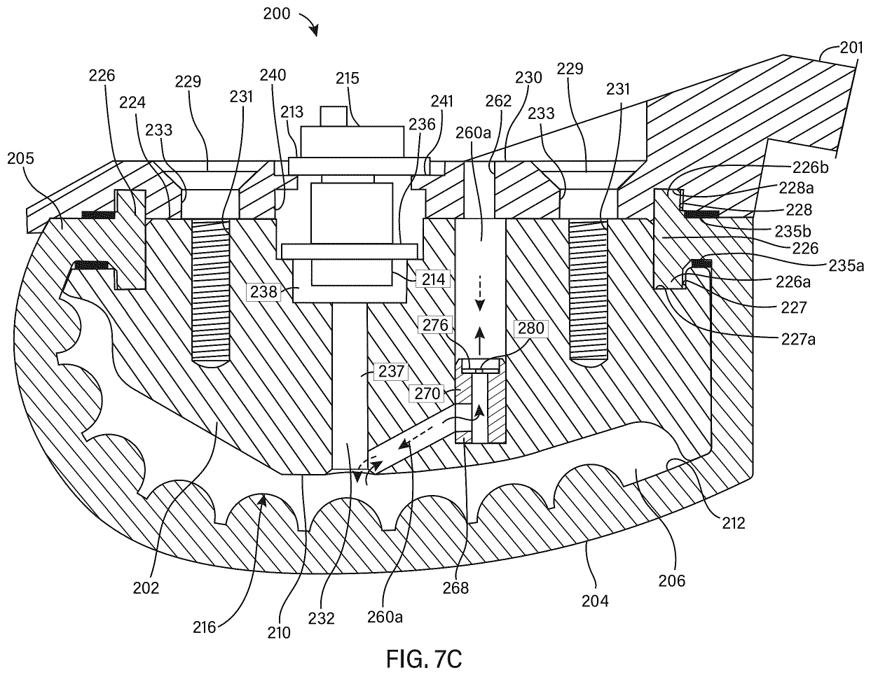

FIGS. 7A and 7B illustrate another exemplary fluidic tactile sensor 200 that can be attached to a surface of interest to enable tactile sensing at the surface. The fluidic tactile sensor 200 includes an orifice fixed in a path fluidly connecting a cell in the sensor to an external pressure environment. The orifice limits the leakage rate of fluid from the cell. The orifice allows the pressure in the cell to be equalized with pressure in the external pressure environment when contact force is not applied to the cell or when sustained contact force is released from the cell, which can ensure a stable pressure profile in the cell and reliable sensor data. Since the orifice is fixed within the path and does not require movable parts to restrict flow, the orifice may be easier to incorporate into the sensor compared to a valve with movable parts.

In the illustrated example, the fluidic tactile sensor 200 includes a core 202 and an elastic skin 204 having a peripheral portion 205 wrapped around a peripheral portion 203 of the core 202. A cell 206 occupies a space defined between a ventral surface 210 of the core 202 and an opposing inner surface 212 of the elastic skin 204. In the assembled state of the sensor, the cell 206 contains a fluid medium. In some examples, the fluid medium can be a compressible fluid (e.g., a gaseous medium such as air). The inner surface 212 of the elastic skin 204 includes a raised surface texture 216 that can be used to widen the dynamic range of the sensor as described in Example II. The core 202, the elastic skin 204, and the raised surface texture 216 can have any combination of the properties described for the corresponding core 102, elastic skin 104, and raised surface texture 116 in Example II.

The fluidic tactile sensor 200 includes a pressure measurement assembly 213 with a pressure transducer 214 to detect and measure pressure changes inside the cell 206. The pressure transducer 214 is disposed in a pressure communications port 232 formed in the core 202. In the illustrated example, a dorsal plate 230 is positioned over a dorsal surface 224 of the core 202, and the peripheral portion 205 of the elastic skin and is secured to the core 202 (e.g., by extending fasteners through the dorsal plate 230 into the core 202). The pressure measurement assembly 213 can extend through a first opening 240 in the dorsal plate 230 to position the pressure transducer 214 in the pressure communications port 232. In some examples, the dorsal plate 230 may be integrated with a distal phalanx 201 of a robotic finger and may function as a fingernail at the tip of the robotic finger.

The peripheral portion 205 of the elastic skin 204 is positioned between the dorsal plate 230 and the core 202. The peripheral portion 205 may have a flanged end 226 with wings 226a, 226b. The wing 226a extends into an annular groove 227 formed in the core 202. The wing 226b extends into an annular groove 228 formed in the dorsal plate 230. The annular grooves 227, 228 are in opposing relation such that the flanged end 226 is situated between opposed surfaces 227a, 228a of the annular grooves 227, 228. In this position, the flanged end 226 can be compressed between the opposed surfaces 227a, 228a by clamping the dorsal plate 230 and the core 202 together.

The dorsal plate 230 and the core 202 can be clamped together using any suitable method. In the illustrated example, the dorsal plate 230 and the core 202 have axially aligned holes 231, 233 for fasteners. The holes 233 in the core 202 include threads to engage threaded fasteners 229, which may be inserted in the holes 233 through the holes 231 in the dorsal plate 230. The holes 231 can be shaped to retain the heads of the threaded fasteners 229, thereby allowing the threaded fasteners 229 to couple the dorsal plate 230 to the core 202. For example, the holes 231 can include countersink holes or counterbored holes that can engage the heads of the threaded fasteners 229.

The force used in tightening the threaded fasteners 229 (or otherwise clamping the dorsal plate 230 to the core 202) can be effective in extruding the flanged end 226 into the corresponding annular grooves 227, 228 and effecting seals between the elastic skin 204 and each of the dorsal plate 230 and core 202. Annular gaskets 235a, 235b may be arranged between the peripheral portion 205 of the elastic skin 204 and corresponding portions of the dorsal plate 230 and core 202 to provide backup sealing at the interfaces between the peripheral portion 205 of the elastic skin 204 and each of the dorsal plate 230 and core 202. The seal formed by the flanged end 226 and annular gaskets 235a, 235b can prevent fluid leakage from the cell via the interfaces between the peripheral portion 205 and each of the dorsal plate 230 and core 202.

In the illustrated example, the pressure communication port 232 includes an opening at the ventral surface 210 of the core 202 and extends from the opening at the ventral surface 210 to the dorsal surface 224 of the core 202. The pressure communication port 232 may have a first bore 238 that is connected to the dorsal surface 224 and a second bore 237 that is connected to the ventral surface 210. In the illustrated example, the pressure transducer 214 is arranged in the first bore 238 and offset from the ventral surface 210 by a length of the second bore 237. In other examples, the pressure transducer 214 may be arranged in the second bore 237 and positioned proximate the opening of the pressure communication port 232 at the ventral surface 210.

The pressure transducer 214 is exposed to the fluid pressure in the cell 206 via the pressure communication port 232. The pressure transducer 214 includes a pressure-sensitive element that can measure fluid pressure and convert the measurements into an electric output signal as described for the pressure transducer 114 in Example II. The pressure transducer 214 can have any of the features described for the pressure transducer 114 in Example II.

The pressure measurement assembly 213 includes a circuit board 236 that is coupled to the pressure transducer 214. The circuit board 236 contains electrical circuitry that can communicate with the pressure transducer 214. For example, the electrical circuitry may receive electrical output signals from the pressure transducer 214 and provide electrical power to the pressure transducer 214.

The pressure measurement assembly 213 may include a sensor adapter 215 with a connector that mates with a corresponding connector on the circuit board 236. In the illustrated example, the sensor adapter 215 is supported on an annular shoulder 241 formed in the first opening 240 in the dorsal plate 230. The interface between the sensor adapter 215 and the annular shoulder 241 may be sealed using any sealing method known in the art so that fluid leakage through this interface is substantially prevented.

The core 202 includes a fluid leakage passage 260 through which the cell 206 may be vented. In the illustrated example, the fluid leakage passage 260 extends from an opening at the ventral surface 210 of the core 202 to an opening at the dorsal surface 224 of the core 202. However, other paths of the fluid leakage passage 260 that would allow venting of the cell 206 through the core 202 are possible. For example, instead of the fluid leakage passage extending from the ventral surface 210 to the dorsal surface 224 of the core 202, the fluid leakage passage may extend from the pressure communication port 232 to the dorsal surface 224. In this case, the fluid leakage passage 260 is fluidly connected to the cell 206 via the opening of the pressure communication port 232 at the ventral surface 210 (i.e., the pressure communication port 232 and fluid leakage passage 260 can share a single opening at the ventral surface 210). For illustration purposes, FIG. 7C shows a fluid leakage passage 260a extending from the pressure communication port 232 to the dorsal surface 224 of the core 202.

Returning to FIG. 7B, the dorsal plate 230 can include a second opening 262 that is aligned with and connected to the opening of the fluid leakage passage 260 at the dorsal surface 224. In some examples, the fluid leakage passage 260 may be fluidly connected to (or exposed to) an ambient environment or a pressurized fluid source through the second opening 262.

The fluidic tactile sensor 200 includes an orifice device 268 fixed within the fluid leakage passage 260. In the illustrated example, the orifice device 268 is arranged in a first bore 266 of the fluid leakage passage 260 proximate to the cell 206. A second bore 264 of the fluid leakage passage 260 extends from the location of the orifice device 268 to the dorsal surface 224 of the core 202. The orifice device 268 includes an orifice adapter 270, which may be attached to a wall of the first bore 266 by any suitable method (e.g., adhesive or threads). The interface between the orifice adapter 270 and the wall of the first bore 266 may be sealed using any suitable method such that fluid leakage via this interface is substantially prevented.

In the illustrated example, the orifice adapter 270 includes a bore 272, which forms a conduit between the bores 266, 264 of the fluid leakage passage 260. An annular shoulder 274 is defined within the bore 272. The orifice device 268 includes a restriction plate 276 mounted on the annular shoulder 274 and extending over the bore 272. An interface between the restriction plate 276 and the annular shoulder 274 may be sealed using any suitable method such that fluid leakage via this interface is substantially prevented.

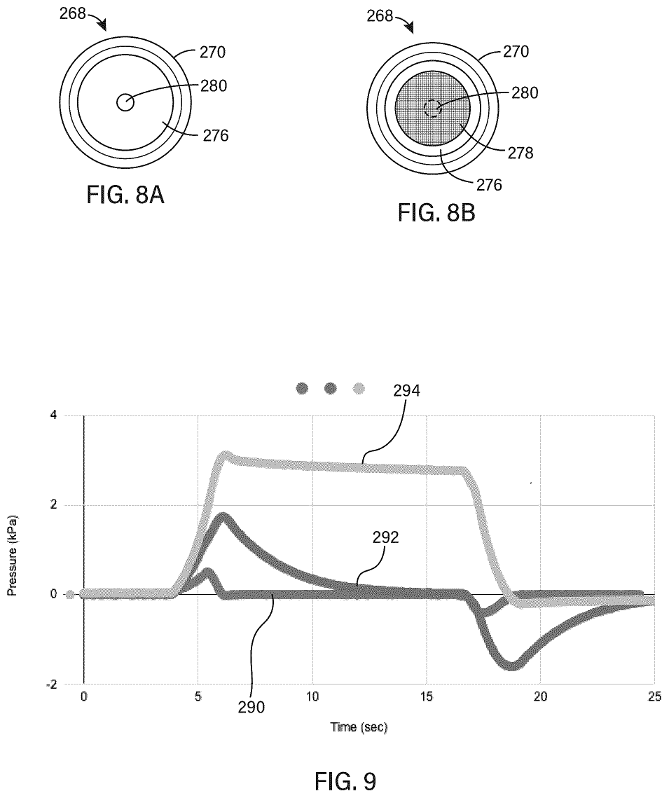

The restriction plate 276, which may also be referred to as an orifice plate, includes an orifice 280 that is aligned with the bore 272 and positioned such that flow through the fluid leakage passage 260 must pass through the orifice 280, which allows the orifice 280 to be effective in limiting a fluid leakage rate of the cell 206. In some examples, the orifice 280 may be located generally in the middle of the restriction plate 276 (see FIG. 8A). In some examples, the orifice 280 can have a circular profile. In some examples, the orifice 280 can be a straight hole having a constant diameter along the axial length of the hole. In other examples, the orifice 280 may have a non-circular profile or variable diameter along the axial length of the hole.

The orifice 280 can be tuned to provide a select time constant τ of the fluid leakage rate of the cell 206. Time constant τ is a parameter that measures how quickly a system responds to a change in input, as known to those skilled in the art. The orifice 280 can be tuned (e.g., the size or flow area of the orifice 280 can be optimized) to provide a select time constant τ. In some examples, the select time constant τ may be based on a select grasp rate (i.e., the percentage of successful attempts a robotic hand makes when trying to pick up an object). In some examples, the orifice 280 may be tuned to provide a time constant τ in a range from 1 to 15 seconds.

The flow rate through the orifice 280, and hence the fluid leakage rate of the cell 206, is dependent on the cross-sectional area of the orifice 280. For an orifice having a circular profile, the flow rate is roughly proportional to the square of the diameter of the orifice. In some examples, the diameter of the orifice 280 can be selected to achieve a desired time constant τ. In some examples, the orifice 280 may have a diameter in a range from 5 microns to 50 microns. In one example, the orifice 280 may have a diameter in a range from 15 to 35 microns (e.g., about 25 microns).

In some examples, the restriction plate 276 may be made of any nonporous material in which an orifice can be formed. In some examples, the restriction plate 276 can be made of a sturdy material (e.g., metal or hard plastic) that can maintain the integrity of the orifice 280. In some examples, the restriction plate 276 may be made of stainless steel. The thickness of the restriction plate 276 can be a minimum thickness to ensure the manufacturability and integrity of the orifice in the plate. In some examples, the thickness of the restriction plate 276 may be in a range from 50 microns to 100 microns for an orifice diameter in a range from 5 microns to 50 microns. The orifice may be formed in the restriction plate 276 using any suitable method for forming precision holes (e.g., by laser cutting).

In some examples, the orifice adapter 270 may include a porous filter arranged to keep residue out of the orifice 280. In one example, as illustrated in FIG. 8B, the porous filter 278 may be attached to the restriction plate 276 (in FIG. 8A), for example, and may extend over the orifice 280. In another example, a porous filter in the form of a plug may be fixed inside the orifice 280. The effect of the porous filter on time constant may be taken into account when determining an optimum size for the orifice.

Fluid may move between the bores 264 and 266 of the fluid leakage passage 260 in a direction to equalize the pressures between these bores. This mechanism can be used to equalize the pressure in the cell 206 with the pressure in an environment to which the fluid leakage passage 260 is fluidly connected (e.g., an ambient environment or a pressurized fluid environment) when contact force is not applied to the elastic skin 204. When contact force is applied to the elastic skin 204, fluid in the cell 206 can be displaced into the first bore 266 and pushed against the orifice 280. The increased pressure of the fluid in the first bore 266 can cause movement of the fluid from the first bore 266 to the second bore 264 at a rate limited by the size of the orifice 280. When the contact force is released from the elastic skin 204, a negative pressure is created in the cell 206 that can draw fluid through the orifice 280 into the cell 206.

FIG. 9 shows orifice pressure over time for various orifice sizes. The pressure profile 290 corresponds to an example fluidic tactile sensor using an orifice device with a 50 micron orifice. The pressure profile 292 corresponds to an example fluidic tactile sensor using an orifice device with a 25 micron orifice. The pressure profile 294 corresponds to an example fluidic tactile sensor using a 5 micron orifice that is blocked with a nonporous plug (corresponding to a scenario where there is no deliberate fluid leakage path from the cell, i.e., the cell is completely sealed).

To generate the example pressure profiles 290, 292, 294, the fluid leakage passage 260 is fluidly connected to external pressure (e.g., ambient pressure) at one end and to pressure in the cell 206 at another end. Contact force (or static load) is applied to the elastic skin 204 covering the cell 206, held, and then released. At time zero, just before the contact force is applied, each of the pressure profiles 290, 292, 294 show that the orifice pressure is the same as the external pressure. The orifice pressure changes under the load on the elastic skin 204. The time at which the orifice pressure becomes negative (or falls below the external pressure) indicates when the contact force was removed from the elastic skin 204. Only the pressure profiles 290 and 292 exhibit substantial negative pressure when the contact force was removed from the elastic skin 204. The negative pressure allows fluid to be sucked into the cell 206 via the orifice 280. Since the fluid leakage passage 260 is fluidly connected to the external environment having the external pressure, the orifice pressure can be seen returning to the external pressure as fluid is drawn into the cell 206 for the pressure profiles 290 and 292.

The pressure profile 294 for the sensor with the blocked 5 micron orifice exhibits a high pressure when the contact force is applied to the elastic skin 204 and does not exhibit a significant negative pressure when the contact force is removed from the elastic skin 204. The pressure profile 294 is representative of the pressure profile of a cell that is sealed from an external environment (i.e., a sensor in which there is no deliberate fluid leakage path between the cell and an external environment).

In FIG. 9, the fluid leakage rate corresponding to the pressure profile 290 (50 micron orifice) has a relatively fast time constant τ. The fluid leakage rate corresponding to the pressure profile 292 (25 micron orifice) has a relatively medium time constant τ. The fluid leakage rate corresponding to the pressure profile 294 (blocked 5 micron orifice) has a substantially zero time constant since there is substantially no leakage from the cell due to the blocked orifice.

In a fluidic tactile sensor where there is no deliberate fluid leakage from the cell (i.e., where the cell is designed to be completely sealed), the internal cell pressure (P_cell) tends to have a positive pressure offset (P_offset) from atmospheric pressure (P_atm). This pressure offset can vary by up to 2 kPa in some applications, which can have a significant impact on the repeatability of the sensor measurements as the internal pressure offset will attempt to equalize with atmospheric pressure over time, which results in a variable offset that changes from sensor to sensor.

In the fluidic tactile sensor 200, the orifice 280 (in an open state) allows the internal cell pressure (P_cell) to quickly equalize with atmospheric pressure (P_atm) (or with a higher pressure if the orifice is in fluid communication with a pressurized fluid source). This eliminates the pressure offset (P_offset). Pressure spikes in the cell resulting from contact with the elastic skin are measured relative to atmospheric pressure (or relative to a higher pressure of a pressurized fluid source). This results in higher repeatability across many sensors (assuming that the orifice diameter is tightly controlled). Sustained contact with the elastic skin of the sensor pushes fluid out of the cell, which causes a vacuum of equal and opposite magnitude to the pressure spike upon release of contact. The vacuum effect can be used as an indicator that sustained contact has been released.

Returning to FIG. 7B, in some examples, the fluid leakage passage 260 can be fluidly connected to ambient pressure, which would allow the cell pressure to equalize to ambient pressure after contact force is released from the elastic skin 204 or when there is no contact force applied to the elastic skin 204. In other examples, it may be advantageous to fluidly connect the fluid leakage passage 260 to a pressurized fluid source having a slightly higher pressure compared to ambient pressure. In this case, if the sensor is functioning correctly, the cell pressure should equalize to a pressure above ambient pressure (i.e., the higher pressure of the pressurized fluid source) after contact force is released from the elastic skin or when there is no contact force applied to the elastic skin. If the cell shows a pressure reading below the higher pressure of the pressurized fluid source under the no contact force condition, this may be used as an indication that the sensor is not working properly.

### Additional Examples

Additional examples based on principles described herein are enumerated below. Further examples falling within the scope of the subject matter can be configured by, for example, taking one feature of an example in isolation, taking more than one feature of an example in combination, or combining one or more features of one example with one or more features of one or more other examples.

Example 1: A fluidic tactile sensor comprises a core having a ventral surface and a dorsal surface; an elastic skin mechanically coupled to the core, the elastic skin having an inner surface and an outer surface, the inner surface in opposing relation to the ventral surface of the core; a cell containing a fluid medium formed in a space defined between the ventral surface of the core and the inner surface of the elastic skin; a fluid leakage passage formed in the core and in fluid communication with the cell; and an orifice member fixed within the fluid leakage passage, the orifice member comprising an orifice tuned to restrict fluid flow through the fluid leakage passage and limit a fluid leakage rate of the cell.

Example 2: The fluidic tactile sensor according to Example 1, wherein the fluid leakage passage is communicatively coupled to ambient pressure.

Example 3: The fluidic tactile sensor according to Example 1, wherein the fluid leakage passage is communicatively coupled to a pressurized fluid source.

Example 4: The fluidic tactile sensor according to any of Examples 1-3, wherein the orifice is tuned to provide a time constant of the fluid leakage rate in a range from 1 to 15 seconds.

Example 5: The fluidic tactile sensor according to any of Examples 1-4, wherein a diameter of the orifice is in a range from approximately 5 microns to 50 microns.

Example 6: The fluidic tactile sensor according to any of Examples 1-4, wherein a diameter of the orifice is in a range from approximately 15 microns to 35 microns.

Example 7: The fluidic tactile sensor according to any of Examples 1-6, wherein the fluid leakage passage has a first opening formed on the ventral surface of the core and a second opening formed on the dorsal surface of the core.

Example 8: The fluidic tactile sensor according to Example 7, wherein the orifice member comprises an orifice adapter fixedly disposed in a first portion of the fluid leakage passage adjacent to the first opening and a restriction plate fixedly mounted within a bore of the orifice adapter, wherein the restriction plate includes the orifice.

Example 9: The fluidic tactile sensor according to any of Examples 1-8, wherein the orifice member comprises a porous filter disposed over or inside the orifice.

Example 10: The fluidic tactile sensor according to any of Examples 1-9, further comprising a pressure transducer arranged to measure fluid pressure inside the cell.

Example 11: The fluidic tactile sensor according to Example 10, wherein the core comprises a pressure communication port in fluid communication with the cell, and wherein the pressure transducer detects the fluid pressure inside the cell through the pressure communication port.

Example 12: The fluidic tactile sensor according to Example 11, wherein the fluid leakage passage is fluidly connected to the pressure communication port and is in fluid communication with the cell through the pressure communication port.

Example 13: The fluidic tactile sensor according to any of Examples 11-12, further comprising a circuit board with circuitry mechanically and communicatively coupled to the pressure transducer.

Example 14: The fluidic tactile sensor according to Example 13, further comprising a dorsal plate disposed adjacent to the dorsal surface of the core, wherein the circuit board is coupled to the dorsal plate.

Example 15: The fluidic tactile sensor according to Example 14, wherein a peripheral portion of the elastic skin is coupled to a peripheral portion of the core, and wherein the dorsal plate extends over the peripheral portion of the elastic skin and applies a force to the peripheral portion of the elastic skin.

Example 16: The fluidic tactile sensor according to Example 15, wherein the peripheral portion of the elastic skin includes a flanged end, wherein a first portion of the flanged end is received in a first annular groove formed in the peripheral portion of the core, wherein a second portion of the flanged end is received in a second annular groove formed in the dorsal plate, and wherein the force applied by the dorsal plate effects a seal between the flanged end and the first and second annular grooves.

Example 17: The fluidic tactile sensor according to Example 16, further comprising a first seal member disposed between the dorsal plate and the peripheral portion of the elastic skin and a second seal member disposed between the peripheral portion of the elastic skin and the peripheral portion of the core.

Example 18: The fluidic tactile sensor according to any of Examples 14-17, wherein the dorsal plate comprises a vent hole fluidly connected to the fluid leakage passage, and wherein the fluid leakage passage is in communication with an environment outside of the core through the vent hole.

Example 19: The fluidic tactile sensor according to any of Examples 1-18, wherein the dorsal plate is integrated with a distal phalanx of a robotic finger.

Example 20: The fluidic tactile sensor according to any of Examples 1-19, wherein the inner surface of the elastic skin comprises a raised surface texture protruding into the cell, and wherein a tuning gap is defined between the raised surface texture and the ventral surface of the core.

Example 21: A fluidic tactile sensor according to Example 20, wherein a tuning gap is defined between the raised surface texture and the ventral surface.

Example 22: The fluidic tactile sensor of Example 21, wherein a height of the tuning gap across the cell is non-uniform.

Example 23: The fluidic tactile sensor of Example 21, wherein a given portion of the raised surface texture is movable between a free position in which a height of the tuning gap is non-zero and an engaged position in which the height of the tuning gap is zero, and wherein the given portion of the raised engages the ventral surface in the engaged position.

Example 24: The fluidic tactile sensor according to Example 23, wherein the height of the tuning gap at the given portion controls a first sensor stiffness range, and wherein a height of the given portion controls a second sensor stiffness range that is different from the first sensor stiffness range.

Example 25: The fluidic tactile sensor according to any one of Examples 23-24, wherein the given portion forms a compression spring in the engaged position that deforms responsively to a force applied to the elastic skin, and wherein the given portion releases itself from the engaged position when the force is removed from the elastic skin.

Example 26: The fluidic tactile sensor according to any one of Examples 20-25, wherein a peripheral portion of the elastic skin is mechanically coupled to the core.

Example 27: The fluidic tactile sensor according to any one of Examples 20-26, wherein the raised surface texture comprises discrete 3D structures arrayed across the inner surface of the elastic skin.

Example 28: The fluidic tactile sensor according to Example 27, wherein at least one of the 3D structures has a spherical profile.

Example 29: The fluidic tactile sensor according to any one of Examples 20-26, wherein the raised surface texture comprises intersecting 3D structures extending across the inner surface of the elastic skin.

Example 30: The fluidic tactile sensor according to Example 29, wherein the 3D structures are linear 3D structures.

Example 31: The fluidic tactile sensor according to Example 29, wherein the intersecting 3D structures form a waffle structure.

Example 32: The fluidic tactile sensor according to any one of Examples 1-31, wherein the ventral surface of the core is nonplanar.

Example 33: The fluidic tactile sensor according to Example 32, wherein the ventral surface of the core comprises an inclined flattened region corresponding to an apical tuft of a fingertip, and wherein a size of the gap at the inclined flattened region is different than a size of the gap at other regions of the ventral surface.

Example 34: The fluidic tactile sensor according to any one of Examples 1-33, wherein the elastic skin comprises an elastomer.

Example 35: The fluidic tactile sensor according to any one of Examples 1-34, wherein the fluid medium is a compressible fluid.

Example 36: The fluidic tactile sensor according to any of Examples 1-35, wherein the fluid medium is air.

1. A fluidic tactile sensor comprising:
a core having a ventral surface and a dorsal surface;
an elastic skin mechanically coupled to the core, the elastic skin having an inner surface and an outer surface, the inner surface in opposing relation to the ventral surface of the core;
a cell containing a fluid medium formed in a space defined between the ventral surface of the core and the inner surface of the elastic skin;
a fluid leakage passage formed in the core and in fluid communication with the cell; and
an orifice member fixed within the fluid leakage passage, the orifice member comprising an orifice tuned to restrict fluid flow through the fluid leakage passage and limit a fluid leakage rate of the cell.

2. The fluidic tactile sensor of claim 1, wherein the fluid leakage passage is communicatively coupled to ambient pressure.

3. The fluidic tactile sensor of claim 1, wherein the fluid leakage passage is communicatively coupled to a pressurized fluid source.

4. The fluidic tactile sensor of claim 1, wherein the orifice is tuned to provide a time constant of the fluid leakage rate in a range from 1 to 15 seconds.

5. The fluidic tactile sensor of claim 1, wherein a diameter of the orifice is in a range from approximately 5 microns to 50 microns.

6. The fluidic tactile sensor of claim 1, wherein the fluid leakage passage has a first opening formed on the ventral surface of the core and a second opening formed on the dorsal surface of the core.

7. The fluidic tactile sensor of claim 6, wherein the orifice member comprises an orifice adapter fixedly disposed in a first portion of the fluid leakage passage adjacent to the first opening and a restriction plate fixedly mounted within a bore of the orifice adapter, wherein the restriction plate includes the orifice.

8. The fluidic tactile sensor of claim 6, wherein the orifice member comprises a porous filter disposed over or inside the orifice.

9. The fluidic tactile sensor of claim 1, further comprising a pressure transducer arranged to measure fluid pressure inside the cell.

10. The fluidic tactile sensor of claim 9, wherein the core comprises a pressure communication port in fluid communication with the cell, and wherein the pressure transducer detects the fluid pressure inside the cell through the pressure communication port.

11. The fluidic tactile sensor of claim 10, wherein the fluid leakage passage is fluidly connected to the pressure communication port and is in fluid communication with the cell through the pressure communication port.

12. The fluidic tactile sensor of claim 10, further comprising a circuit board with circuitry, the circuit board mechanically and communicatively coupled to the pressure transducer.

13. The fluidic tactile sensor of claim 12, further comprising a dorsal plate disposed adjacent to the dorsal surface of the core, wherein the circuit board is coupled to the dorsal plate.

14. The fluidic tactile sensor of claim 13, wherein a peripheral portion of the elastic skin is coupled to a peripheral portion of the core, and wherein the dorsal plate extends over the peripheral portion of the elastic skin and applies a force to the peripheral portion of the elastic skin.

15. The fluidic tactile sensor of claim 14, wherein the peripheral portion of the elastic skin includes a flanged end, wherein a first portion of the flanged end is received in a first annular groove formed in the peripheral portion of the core, wherein a second portion of the flanged end is received in a second annular groove formed in the dorsal plate, and wherein the force applied by the dorsal plate effects a seal between the flanged end and the first and second annular grooves.

16. The fluidic tactile sensor of claim 15, further comprising a first seal member disposed between the dorsal plate and the peripheral portion of the elastic skin and a second seal member disposed between the peripheral portion of the elastic skin and the peripheral portion of the core.

17. The fluidic tactile sensor of claim 13, wherein the dorsal plate comprises a vent hole fluidly connected to the fluid leakage passage, and wherein the fluid leakage passage is in communication with an environment outside of the core through the vent hole.

18. The fluidic tactile sensor of claim 1, wherein the inner surface of the elastic skin comprises a raised surface texture protruding into the cell, and wherein a tuning gap is defined between the raised surface texture and the ventral surface of the core.

19. The fluidic tactile sensor of claim 18, wherein the raised surface texture comprises discrete 3D structures arrayed across the inner surface of the elastic skin.

20. The fluidic tactile sensor of claim 1, wherein the fluid medium is a compressible fluid.
